(19) United States
(12) Patent Application Publication
(10) Pub. No.: US 2025/0385061 A1
(43) Pub. Date: Dec. 18, 2025

(54) RELAY FOR VEHICLE

(71) Applicant: SUBARU CORPORATION, Tokyo (JP)

(72) Inventors: Masahiro KAWAHARA, Tokyo (JP); Tomoyuki URAYAMA, Tokyo (JP); Wakaba NIKAIDOH, Tokyo (JP)

(73) Assignee: SUBARU CORPORATION, Tokyo (JP)

(21) Appl. No.: 19/223,706

(22) Filed: May 30, 2025

(30) Foreign Application Priority Data
Jun. 13, 2024 (JP) 2024-096193

(51) Int. Cl. H01H 50/14; H01H 50/56; H01H 50/64

(52) U.S. Cl. CPC H01H 50/14; H01H 50/56; H01H 50/642; H01H 2231/026

(57) ABSTRACT

A relay for a vehicle includes terminals in a pair and a plate. The terminals are configured to be separated from each other in a non-conductive state and in contact with each other in a conductive state. The plate is configured to be disposed between the terminals, in the non-conductive state. The plate is configured such that, in the non-conductive state, the plate is in contact with at least one of respective contacts of the terminals. The plate is configured such that, when the terminals are coupled to each other, the plate is removed from a gap between the terminals and slides on the at least one of the contacts of the terminals.

### CROSS-REFERENCE TO RELATED APPLICATIONS

The present application claims priority from Japanese Patent Application No. 2024-096193 filed on Jun. 13, 2024, the entire contents of which are hereby incorporated by reference.

### BACKGROUND

The disclosure relates to a relay for a vehicle.

A vehicle includes a relay that controls on and off of a circuit between a battery and an electrical component. For example, the relay may sometimes be disposed in an engine room. For example, a low air temperature in the engine room leads to, inside the relay, condensation of water vapor to water droplets and the water droplets may adhere to surfaces between terminals. The water droplets, when frozen, may hinder the terminals from being electrically coupled to each other.

For example, Japanese Unexamined Patent Application Publication (JP-A) No. 2022-68927 discloses an electromagnetic relay to address the above problem. JP-A No. 2022-68927 discloses that, when a location region of the electromagnetic relay is a region in which the electromagnetic relay is likely to be frozen and a current season corresponds to a season during which the electromagnetic relay is subjected to freezing, the electromagnetic relay is repeatedly opened and closed at a predetermined timing for a predetermined duration, thereby causing the electromagnetic relay to vibrate. Such vibration prevents the electromagnetic relay from being frozen.

### SUMMARY

An aspect of the disclosure provides a relay for a vehicle. The relay includes terminals in a pair and a plate. The terminals are configured to be separated from each other in a non-conductive state and in contact with each other in a conductive state. The plate is configured to be disposed between the terminals, in the non-conductive state. The plate is configured such that, in the non-conductive state, the plate is in contact with at least one of respective contacts of the terminals. The plate is configured such that, when the terminals are coupled to each other, the plate is removed from a gap between the terminals and slides on the at least one of the contacts of the terminals.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic sectional view of a relay according to an embodiment, with terminals not coupled to each other; and

FIG. 2 is a schematic sectional view of the relay according to the embodiment, with the terminals coupled to each other.

### DETAILED DESCRIPTION

In JP-A No. 2022-68927, the vibration of the electromagnetic relay is repeated at a predetermined timing for a predetermined duration. Accordingly, power consumption increases. This is a waste of power.

It is desirable to provide a relay for a vehicle capable of reducing power consumption used for removing ice from a surface of a terminal.

Hereinafter, an embodiment of the disclosure will be described in detail with reference to the accompanying drawings. Specific dimensions, materials, and numerical values described in the embodiment are merely examples for a better understanding of the disclosure, and do not limit the disclosure unless otherwise specified. In this specification and the drawings, duplicate descriptions are omitted for elements having substantially the same functions and configurations by assigning the same sign. Furthermore, elements not directly related to the disclosure are omitted from the figures.

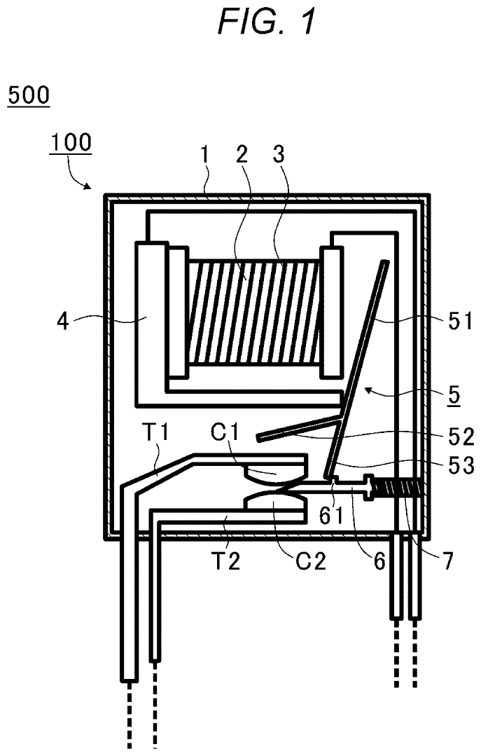

FIG. 1 is a schematic sectional view of a relay 100 according to the embodiment, with terminals T1 and T2 not coupled to each other. For example, the relay 100 is disposed in an engine room of a vehicle 500. The relay 100 controls on and off of a circuit between a battery and an electrical component (both of which are not illustrated).

For example, the relay 100 includes a case 1, an iron core 2, a coil 3, a bracket 4, the terminals T1 and T2, an iron piece 5, and a plate 6. The relay 100 may further include other constituent elements. The relay 100 does not necessarily include at least one of the above-described constituent elements.

The case 1 accommodates the constituent elements of the relay 100. For example, the case 1 is fixed to a relay holder in the engine room.

The coil 3 is wound around the iron core 2. The coil 3 is coupled to the battery (not illustrated). When current flows through the coil 3, the iron core 2 generates a magnetic force. For example, in the present embodiment, the iron core 2 is fixed to any position of the case 1 by use of the bracket 4. The way of fixing of the iron core 2 to the case 1 is not limited thereto. For example, in another embodiment, the iron core 2 may be directly fixed to the case 1, and the relay 100 does not necessarily include the bracket 4.

The terminals T1 and T2 are coupled to the battery. An electrical component (not illustrated) is provided in the circuit including the terminals T1 and T2 and the battery. In FIG. 1, the terminals T1 and T2 are separated from each other, and the terminals T1 and T2 are not electrically coupled to each other (non-conductive state). In the non-conductive state, no power is supplied to the electrical component.

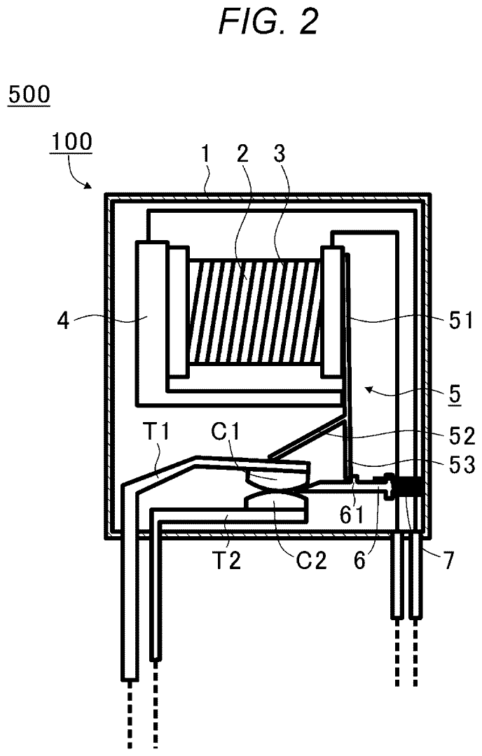

FIG. 2 is a schematic sectional view of the relay 100 according to the embodiment, with the terminals T1 and T2 coupled to each other. In FIG. 2, the terminals T1 and T2 are in contact with each other, and the terminals T1 and T2 are electrically coupled to each other (conductive state). In the conductive state, power is supplied to the electrical component.

Referring to FIG. 1, in the present embodiment, the terminal T1 is a movable terminal, and the terminal T2 is a fixed terminal. The terminal T1 includes a contact C1, and the terminal T2 includes a contact C2. The contacts C1 and C2 are separated from each other in the non-conductive state and are in contact with each other in the conductive state. In the non-conductive state, an air gap is between the contacts C1 and C2.

Referring to FIG. 2, in the conductive state, the magnetic force from the iron core 2 causes the iron piece 5 to push the movable terminal T1 of the terminals T1 and T2 toward the fixed terminal T2. This allows the contacts C1 and C2 to be brought into contact with each other, and the terminals T1 and T2 are electrically coupled to each other.

In one example, the iron piece 5 is configured to be swingable about a predetermined position. For example, in the present embodiment, a substantially central area of the iron piece 5 is swingably supported by the bracket 4. The structure for supporting the iron piece 5 is not limited thereto. For example, in another embodiment, another position of the iron piece 5 may be swingably supported by the bracket 4 or the case 1.

For example, in the present embodiment, the iron piece 5 includes a first member 51 to be brought into contact with the iron core 2, a second member 52 to be brought into contact with the terminal T1, and a third member 53 being in contact or to be brought into contact with the plate 6. Referring to FIG. 1, in the present embodiment, in the non-conductive state, the first member 51 is not in contact with the iron core 2, and the second member 52 is not in contact with the terminal T1. In the non-conductive state, the third member 53 may or may not be in contact with the plate 6.

For example, in the present embodiment, the first member 51 and the second member 52 extend in directions intersecting each other. Furthermore, for example, in the present embodiment, the third member 53 extends on an extension line of the first member 51 from a coupling point between the first member 51 and the second member 52.

For example, an elastic body (not illustrated) may be provided for maintaining the iron piece 5 in the orientation illustrated in FIG. 1. The elastic body is for example, a spring.

Referring to FIG. 2, when current flows through the coil 3, the first member 51 is attracted toward the iron core 2 by a magnetic force and is brought into contact with the iron core 2. Consequently, the iron piece 5 swings, and the second member 52 is brought into contact with the terminal T1. The second member 52 further pushes the terminal T1 toward the terminal T2. This allows the contact C1 of the terminal T1 to be brought into contact with the contact C2 of the terminal T2, and the terminals T1 and T2 are electrically coupled to each other.

As described above, for example, the relay 100 is disposed in the engine room of the vehicle 500. For example, when a temperature in the engine room is low, for example, in winter, in the non-conductive state, water vapor is condensed to water droplets inside the case 1 and the water droplets may adhere to surfaces of the contacts C1 and C2. The water droplets, when frozen, hinder the terminals T1 and T2 from being electrically coupled to each other. In the present embodiment, the relay 100 includes the plate 6 in order to address such a problem.

Referring to FIG. 1, in the non-conductive state, the plate 6 is disposed between the contacts C1 and C2 of the terminals T1 and T2. In one example, in the non-conductive state, the plate 6 is in contact with at least one contact of the terminals T1 and T2. Such a configuration prevents, in the non-conductive state, the adhesion of water droplets to the contacts C1 and C2.

For example, in the present embodiment, the plate 6 includes an insulating material such as ceramic made of aluminum oxide or a phenol resin. In the non-conductive state, the plate 6 is in contact with both of the contacts C1 and C2. With such a configuration, in the non-conductive state, the plate 6 is sandwiched between the terminals T1 and T2. Thus, the plate 6 is stabilized. However, for example, when it is predicted that water droplets are likely to adhere to one of the contacts C1 and C2, in the non-conductive state, the plate 6 may simply be in contact with one of the contacts C1 and C2. In this case, the plate 6 does not necessarily include an insulating material.

For example, the plate 6 extends in a direction intersecting a direction (up-down direction in FIG. 1) in which the contact C1 faces the contact C2. In the present embodiment, the plate 6 extends in a direction (left-right direction in FIG. 1) perpendicular to the direction in which the contact C1 faces the contact C2.

The plate 6 includes a protrusion (connector) 61 for engagement with the third member 53 of the iron piece 5. The third member 53 is in contact with the protrusion 61. The third member 53 may not always be in contact with the protrusion 61. For example, the third member 53 may start to be brought into contact with the protrusion 61 while the first member 51 moves toward the iron core 2. The connector for engagement of the iron piece 5 with the plate 6 is not limited to the protrusion. For example, the plate 6 may include a groove as a connector, and an end of the third member 53 may be inserted into the groove. Furthermore, for example, the iron piece 5 may be engaged with the plate 6 by use of a connector such as a hinge.

The iron piece 5 is configured such that while the first member 51 moves toward the iron core 2, the third member 53 moves in a direction away from an air gap between the terminals T1 and T2. In the present embodiment, the iron piece 5 is configured such that while the first member 51 moves toward the iron core 2, the third member 53 moves in the direction perpendicular to the direction in which the contact C1 faces the contact C2.

In the present embodiment, the relay 100 includes a spring (elastic body) 7 that presses the plate 6 toward the air gap between the terminals T1 and T2. For example, the spring 7 is fixed to the inner surface of the case 1. The elastic body is not limited to the spring. For example, the elastic body may be rubber or the like.

With such a configuration, when current flows through the coil 3 and the first member 51 is attracted toward the iron core 2 by a magnetic force, the iron piece 5 swings. This allows the third member 53 to move in the direction away from the air gap between the terminals T1 and T2. The third member 53 pushes the protrusion of the plate 6 in the direction away from the air gap. The plate 6 is thus removed from the air gap. When being removed from the air gap, the plate 6 slides on the contacts C1 and C2. With such a configuration, when ice is formed on the contacts C1 and C2, the plate 6 can remove the ice from the contacts C1 and C2.

The relay 100 as described above includes the terminals T1 and T2 and the plate 6. The terminals T1 and T2 are separated from each other in the non-conductive state and are in contact with each other in the conductive state. The plate 6 is disposed between the terminals T1 and T2, in the non-conductive state. In the non-conductive state, the plate 6 is in contact with at least one of the contacts of the terminals T1 and T2. When the terminals T1 and T2 are coupled to each other, the plate 6 is removed from the air gap between the terminals T1 and T2, and slides on the at least one contact of the terminals T1 and T2. Such a configuration prevents, in the non-conductive state, the adhesion of water droplets to the contacts C1 and C2. Additionally, such a configuration can achieve the removal of ice from the contacts C1 and C2 at the time of activation. Furthermore, such a configuration does not use power for applying energy to the relay 100 at timing other than the time of activation. Thus, it is possible to reduce power consumption used for removing ice from the surface of the terminal, for example, as compared with a case of causing the relay to vibrate at a predetermined timing for a predetermined duration as in JP-A No. 2022-68927.

The relay 100 includes the iron core 2 and the iron piece 5. The iron piece 5 is configured, in the conductive state, to push the movable terminal T1 of the terminals T1 and T2 by the magnetic force from the iron core 2. When the terminals T1 and T2 are coupled to each other, the plate 6 is moved by the iron piece 5 and removed from the air gap between the terminals T1 and T2. With such a configuration, the existing iron piece 5 can be used as a structure for moving the plate 6. Thus, the design can be simplified.

In the relay 100, the plate 6 includes the insulating material, and in the non-conductive state, the plate is in contact with both of the contacts C1 and C2 of the terminals T1 and T2. With such a configuration, in the non-conductive state, the plate 6 is sandwiched between the terminals T1 and T2. Thus, the plate 6 is stabilized.

Although the preferred embodiment of the disclosure has been described above with reference to the accompanying drawings, it goes without saying that the disclosure is not limited to this embodiment. It will be apparent to those skilled in the art that various modifications or alterations can be contrived and implemented within the scope described in the claims, and it is naturally understood that these modifications and alterations also fall within the technical scope of the disclosure.

1. A relay for a vehicle, the relay comprising:
terminals in a pair, the terminals being configured to be separated from each other in a non-conductive state and in contact with each other in a conductive state; and
a plate configured to be disposed between the terminals in the non-conductive state, wherein
the plate is configured such that, in the non-conductive state, the plate is in contact with at least one of respective contacts of the terminals, and
the plate is configured such that, when the terminals are coupled to each other, the plate is removed from a gap between the terminals and slides on the at least one of the contacts of the terminals.

2. The relay according to claim 1, further comprising
an iron core; and
an iron piece configured to, in the conductive state, push a movable terminal of the terminals by a magnetic force from the iron core, wherein
the plate is configured such that, when the terminals are coupled to each other, the plate is moved by the iron piece and removed from the gap between the terminals.

3. The relay according to claim 1, wherein
the plate comprises an insulating material, and
the plate is configured such that, in the non-conductive state, the plate is in contact with both of the contacts of the terminals.

4. The relay according to claim 2, wherein
the plate comprises an insulating material, and
the plate is configured such that, in the non-conductive state, the plate is in contact with both of the contacts of the terminals.
